(19) United States
(12) Patent Application Publication
(10) Pub. No.: US 2008/0256872 A1
(43) Pub. Date: Oct. 23, 2008

(54) Sliding Door System Comprising a Drive Device Located in a Transom

(75) Inventor: Andreas Finke, Gevelsberg (DE)

Correspondence Address: COHEN, PONTANI, LIEBERMAN & PAVANE LLP, 551 FIFTH AVENUE, SUITE 1210, NEW YORK, NY, 10176, US

(73) Assignee: Dorma GmbH + Co. KG, Ennepetal (DE)

(21) Appl. No.: 11/596,424

(22) PCT Filed: May 10, 2005
(86) PCT No.: PCT/EP2005/005014

§ 371 Date: Nov. 10, 2006

(30) Foreign Application Priority Data
May 12, 2004 (DE) 10 2004 023 926.6

(51) Int. Cl. E05F 15/14

(52) U.S. Cl. 49/360

(57) ABSTRACT

A sliding door system including a transom; at least one door leaf movable along the transom; an endless traction mechanism traction-resistantly connected to the at least one door leaf; a drive device for driving the endless traction mechanism, the drive device comprising a driven pulley guiding the endless traction mechanism; a rotational body torsion-resistantly connected to the driven pulley and rotatably supported by the transom, the rotational body comprises a coupling member; a locking bolt displaceably supported by the transom; and an electromechanical actuation device. The electromechanical actuation device is operable to cause the locking bolt to interlock with the coupling member of the rotational body to lock the at least one door leaf relative to the transom.

The invention relates to a sliding door system with a drive device disposed in a transom, according to the generic part of patent claim 1.

Generally, sliding door systems of the species mentioned above are automatic doors substantially consisting of glass, the opening operation being effected through an electrical impulse picked up by a drive device, the closing operation being automatically carried out with a time delay. Moreover, the ability to lock firmly one or more door leaves is required, with the door being open and being closed as well. In addition to manually actuated locking systems, automatically engaging locking systems are used. The invention is based on this type of locking system.

In particular, when locking a closed door, it is imperative to guarantee that no opening slot remains between adjoining door leaves.

In DE 44 15 708 C1 a locking system is described for the drive of a sliding door, wherein a tappet cooperates non-positively and positively with a continuous toothed belt. The tappet has a cam, which cooperates with a hook-shaped locking system. On the one hand, the locking hook is actuated via the cam, which travels over a releasing catch, and on the other hand via the strand of the drive belt.

The object of the invention is to improve the response characteristics of the locking system for a sliding door system of the species mentioned above, i.e. it is intended that the locking can be effectively performed, even after the sliding door has been displaced over a very short distance only, and that the locking system does not consist of a rod locking system.

The invention solves the given problem with the teaching according to claim 1.

Further preferred embodiments of the invention are set forth in the dependent claims.

A driven pulley, preferably formed as a toothed disc, of the drive device effecting the sliding movement of the door leaf, according to the invention, is torsion resistantly secured at a rotational body, which, basically may be optionally embodied, and if necessary, may be an integral part of the driven pulley. It is essential that the rotational body has engaging or locking components, the disposition thereof at the rotational body being such that, in accordance with an impulse emitted by the locking control, they can engage with or disengage from a displaceable locking bolt, which is supported for example in the transom, even after the door was displaced over a very short sliding distance only. With an appropriate presetting of the rotational body or of engaging or locking components disposed at the rotational body, in harmonization with the locking control, it may be guaranteed for example that the locking system responds exactly when the door leaf is completely closed.

In an advantageous embodiment of the invention, the rotational body may be formed as a locking disc, i.e. the driven pulley is torsion resistantly connected to a locking disc which rotates together with the driven pulley, complementary locking components being disposed at the locking disc and at a locking bolt, which, in accordance with an impulse of a locking control, is charged by the electromechanical actuation device and is displaceably supported in the transom.

According to the invention, the locking disc is a torsion resistant rotational body, however releasably linked to the driven pulley, the form of said body being able to be adapted, in particular with regard to the engaging and locking components, to the respective requirements, moreover, in the event of wear, the rotational body is exchangeable.

According to another feature of the invention, the locking disc is torsion resistantly connected to a shaft passing torsion resistantly through the driven pulley, the shaft being rotatably supported in a bearing disposed in the transom, thus allowing for a simple coaxial arrangement of the driven pulley and the locking disc.

According to the invention, the locking disc is physically embodied in a pot-shape or bell-shape, a simple connection of the locking disc and the shaft being achieved, if a bell-bottom of a bell is clamped to the shaft.

In this case, the part of the bell, which forms the bell envelope, may have one or more locking components extending over the envelope circumference, which components may consist for example of apertures in the bell envelope, into which, in a locking position, a free end of the locking bolt engages, which is displaceably supported in the transom. Basically, the form of the locking components in the area of the envelope circumference of the bell envelope, or of the complementary locking components at the locking bolt may be optional; for example a toothing could be provided at the exterior wall of the bell envelope, in which toothing a corresponding mating toothing of the locking bolt engages.

According to an exemplary embodiment of the invention, the electromechanical actuation device is formed as a bistable electromagnet, i.e. the electromagnet is maintained in its respective final position by means of two windings and in accordance with the impulse respectively. In this case, it has proven to be useful to dispose an intermediate lever between the push-rod of the actuation device and the locking bolt, which lever is pivotably linked to both the push-rod and the locking bolt, and is rotatable about a rotating shaft, which is stationary linked to the transom. The intermediate lever, pivoted by means of the push-rod of the actuation device, thus effects the locking or unlocking.

Provided that, in another embodiment of the invention, the actuation device consists of a stable, i.e. non self-holding electromagnet, the invention proposes that the intermediate lever has a permanent magnet at one free end, such as to dispose, in the area of the permanent magnet at the intermediate lever, a permanent magnet stationary fixed at the transom, with the pole faces of the permanent magnets facing each other having a like polarity, such that, in the respective final position of the push-rod of the electromechanical actuation device, the permanent magnets repelling each other have the maximal distance. When using a stable electromagnet in such a device, it can be guaranteed that the locking bolt reliably remains in the locked or in the unlocked position. Naturally, it is likewise possible to use an electric motor as the actuation device instead of a magnet.

In the following, the invention will be explained in more detail based on two diagrammatically illustrated exemplary embodiments, in which:

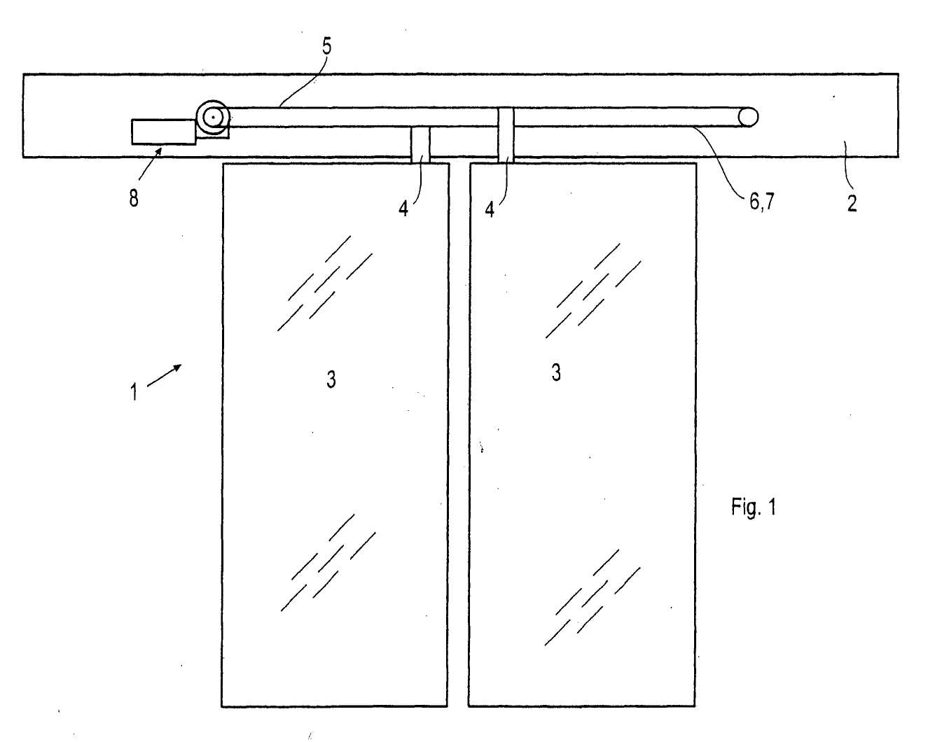

FIG. 1 shows a diagrammatic view of the sliding door system;

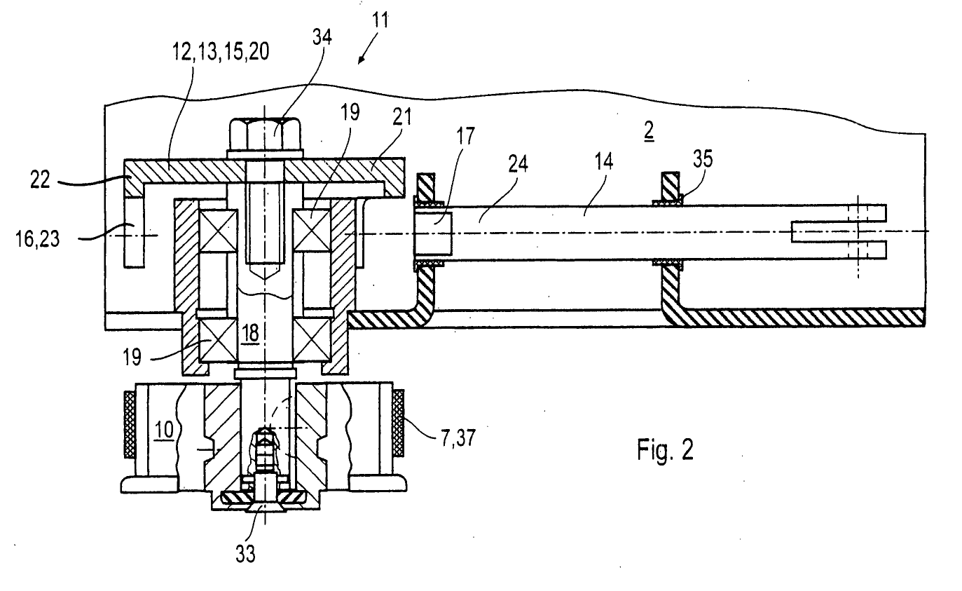

FIG. 2 shows an enlarged illustration, in relation to FIG. 1, of a partial horizontal section through a transom with a driven pulley of the drive and the locking system being disengaged;

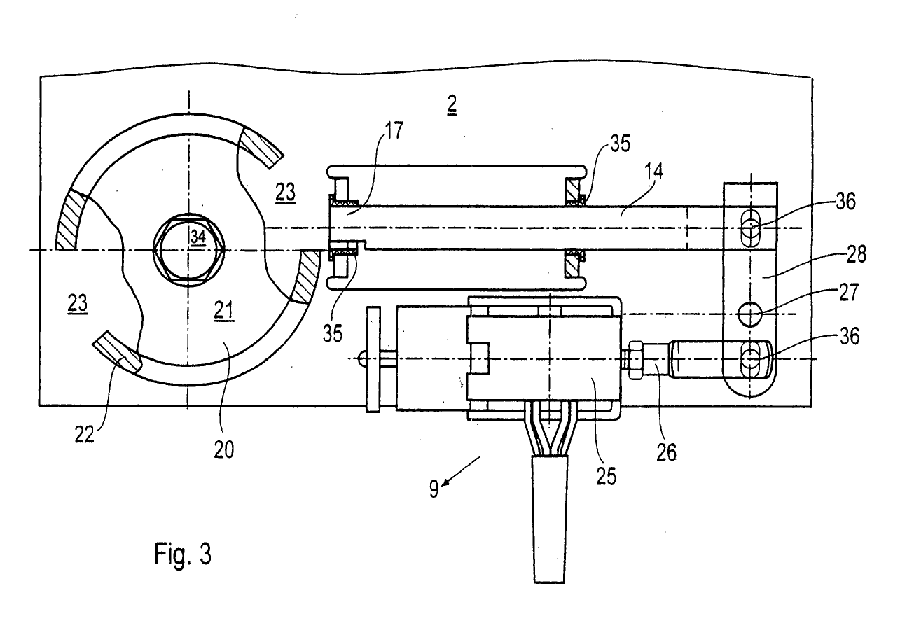

FIG. 3 shows a vertical partial section through the transom according to FIG. 2, the locking system being disengaged;

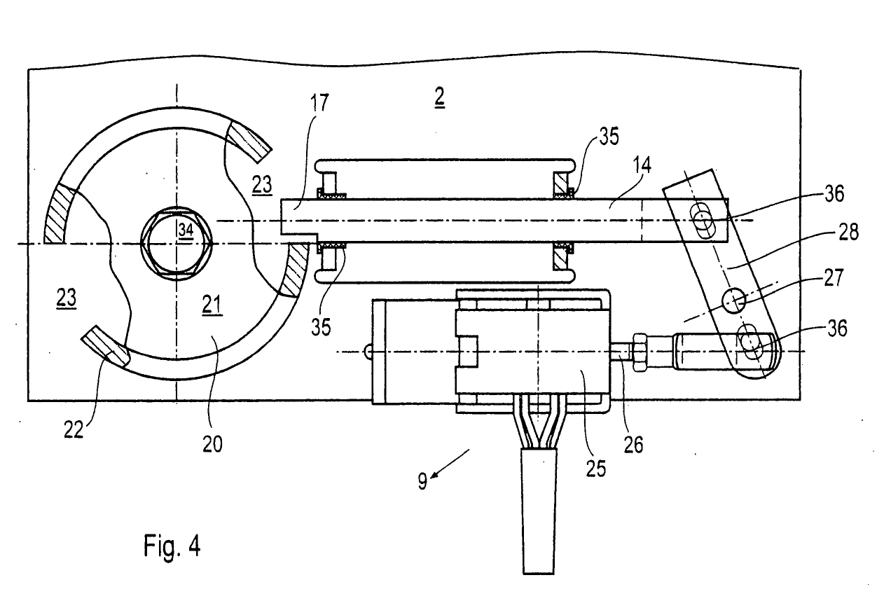

FIG. 4 shows the vertical partial section through the transom according to FIG. 3, the locking system being engaged; and

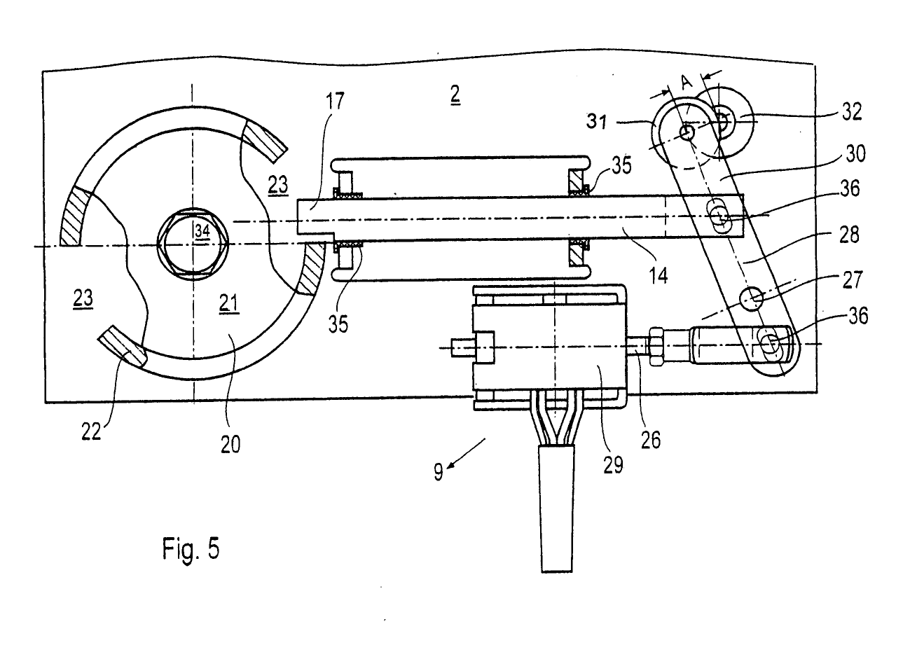

FIG. 5: shows the vertical partial section through the transom according to FIG. 4, where a stable electromagnet is used.

As shown in the exemplary embodiment of FIG. 1, a sliding door system 1 consists of two door leaves 3, which are displaceably guided in or at a transom 2 by means of a roller rail (not illustrated). A drive device generally identified by 8 drives an endless traction means 7, one door leaf 3 being connected to the upper strand 5 and a second door leaf 3 to the lower strand 6 of the endless traction means 7 by means of one respective connecting member 4.

As revealed in FIG. 2, the endless traction means 7, formed as a toothed belt 37, is guided around a driven pulley 10 of the drive system 8, not shown in FIG. 2. A shaft 18, while being torsion resistantly supported in the driven pulley 10 by means of a screw connection 33 and, at the other end, being supported by means of a bearing 19 in the transom 2, passes through the driven pulley 10. The front-end portion of the shaft 18, supported in the transom 2, is contained in a rotational body 12, which, together with a locking bolt 14, which is displaceably supported in bearings 35 of the transom 2, forms a coupling member 13. The coupling member 13 virtually constitutes a locking disc 15, which, in the exemplary embodiment, is represented as a bell 20. As can be seen, a bell-bottom 21 is clamped to the shaft 18 by means of a screw connection 34.

As also depicted in FIGS. 3 to 5, apertures 23 are provided in the bell envelope 22. These apertures 23 form the locking components 16, which are complementary to the locking components 17 at the free end of the locking bolt 14 and thus constitute the locking system generally identified by 11.

In the exemplary embodiment according to FIGS. 3 and 4, the electromagnetical actuation device consists of a bistable electromagnet, i.e. by using two separately controllable windings, in accordance with the locking impulse, the locking bolt 14 is able to engage in the aperture 23 or to disengage from the aperture 23. The number of apertures 23 extending over the circumference of the bell envelope 22 can be adapted to the respective circumstances. As FIGS. 3 to 5 further reveal, an intermediate lever 28 is linked, on its one side, to the push-rod 26 of the actuation device 9 and, on the other side, to the locking bolt 14, which lever is respectively supported in swivel joints 36 at the push-rod 26 and at the locking bolt 14. The intermediate lever 28 pivots about a rotating shaft 27, which is stationary disposed at the transom 2.

A second exemplary embodiment according to FIG. 5 is based on using a stable electromagnet, i.e. non self-holding electromagnet; for reliably securing the locking bolt 14 in the locking position or in the unlocking position, a permanent magnet 31 is disposed in the area of the free end 30 of the intermediate lever 28, which magnet cooperates with a permanent magnet 32 stationary disposed at the transom 2. In this case, the polarity is chosen such that both electromagnets repel each other and, in the illustrated locking position, they have a maximal distance A. When switching the actuation device 9, the electromagnet 31 pivots to the right side (not illustrated) in the plane of the illustration, beyond the position of the electromagnet 32, and thus holds the locking bolt 14 in the unlocked position.

### LIST OF REFERENCE NUMERALS

1 sliding door system
2 transom
3 door leaf
4 connecting member
5 upper strand
6 lower strand
7 endless traction means
8 drive device
9 electromechanical actuation device
10 driven pulley
11 locking
12 rotational body
13 coupling member
14 locking bolt
15 locking disc
16 locking component
17 locking component
18 shaft
19 bearing
20 bell
21 bell-bottom
22 bell envelope
23 apertures
24 free end
25 bistable electromagnet
26 push-rod
27 rotating shaft
28 intermediate lever
29 stable electromagnet
30 free end
31 permanent magnet
32 permanent magnet
33 screw connection
34 screw connection
35 bearing
36 swivel joints
37 toothed belt
A maximal distance

1.-12. (canceled)

13. A drive device for a sliding door system comprising at least one door leaf guided along a transom, the drive device comprising:
a pulley which can be driven in rotation by a drive;
an endless traction mechanism guided around the pulley for moving at least one door leaf linked to the traction mechanism;
a coupling member which is mounted for rotation in the transom, the coupling member being fixed against rotation with respect to the pulley;
a locking bolt which is displaceably supported in the transom and can be moved to engage the coupling member and thereby prevent rotation of the pulley; and
an electromechanical actuation device which moves the locking bolt in response to an impulse emitted by a locking control.

14. The drive device of claim 13, wherein the coupling member comprises a locking disc having a locking component, the locking bolt having a complementary locking component.

15. The drive device of claim 14, further comprising a shaft fixed against rotation to the driven pulley and the locking disc.

16. The drive device of claim 15, further comprising a bearing supported by the transom, the shaft being rotatably supported by the bearing.

17. The drive device of 16, wherein the locking disc comprises a bell having a bell-bottom clamped to the shaft.

18. The drive device of claim 17, wherein the bell has a bell envelope, the locking component of the locking disk extending over a circumference of the bell envelope.

19. The drive device of claim 18, wherein the bell envelope has an aperture which forms the locking component of the locking disk.

20. The drive device of claim 19, wherein the locking bolt is in a locking position when a free end of the locking bolt is in the aperture of the bell envelope.

21. The drive device of claim 13, wherein the actuation device comprises a bistable electromagnet.

22. The drive device of 13, further comprising an intermediate lever, and a shaft disposed between a push-rod of the actuation device and the locking bolt and stationarily connected to the transom, the intermediate lever being pivotably connected to the push-rod, the shaft, and the locking bolt.

23. The drive device of claim 13, wherein the actuation device comprises an electromagnet.

24. The drive device of claim 23, further comprising an intermediate lever, and a shaft disposed between a push-rod of the actuation device and the locking bolt and stationarily connected to the transom, the intermediate lever being pivotably connected to the push-rod, the shaft, and the locking bolt, the intermediate lever having a free end which is closer to the push-rod than to the rotating shaft, and a first permanent magnet attached to the free end, the drive device further comprising a second permanent magnet disposed adjacent to the first permanent magnet and stationarily supported by the transom, the polarities of the first and second permanent magnets are such that the first and second permanent magnets repel each other when the push-rod is in a final position.
